(19) United States
(12) Patent Application Publication
(10) Pub. No.: US 2017/0323260 A1
(43) Pub. Date: Nov. 9, 2017

(54) SHIPPING REQUEST INTEGRATED MANAGEMENT METHOD AND SYSTEM USING CARGO TRACKING APPLICATION

(71) Applicant: Sung Hyun KIM, Seoul (KR)

(72) Inventor: Sung Hyun KIM, Seoul (KR)

(73) Assignee: Sung Hyun KIM, Seoul (KR)

(21) Appl. No.: 15/497,234

(22) Filed: Apr. 26, 2017

(30) Foreign Application Priority Data
May 3, 2016 (KR) 10-2016-0054687

(51) Int. Cl. G06Q 10/08; H04W 4/04; H04W 4/02; H04L 29/08

(52) U.S. Cl. CPC G06Q 10/0833; H04W 4/046; H04W 4/025; G06Q 10/0835; H04L 67/04; H04L 67/18

(57) ABSTRACT

A method for integrating and managing a shipment request using a cargo tracking application, the method includes: accessing, by a portable terminal, a cargo shipment management server through the application, receiving shipment course items of cargo, and displaying the shipment course items; receiving, by the portable terminal, an input screen for shipment details information from the cargo shipment management server, displaying the input screen, receiving the shipment details information, and transmitting the shipment details information to the cargo shipment management server; completing, by the cargo shipment management server, a receipt of a shipment request by receiving the shipment details information and providing shipment request receipt information to the portable terminal; providing, by the cargo shipment management server, the portable terminal with information about a car dispatching of a container truck; and providing, by a ship location providing server, the portable terminal with information about a location of a ship.

### CROSS REFERENCE TO RELATED APPLICATION

The present application claims the benefit of Korean Patent Application No. 10-2016-0054687 filed in the Korean Intellectual Property Office on May 3 2016, the entire contents of which are incorporated herein by reference.

### BACKGROUND OF THE INVENTION

### 1. Technical Field

An embodiment of the present invention relates to a method and system for integrating and managing a shipment request using a cargo tracking application.

### 2. Description of the Related Art

In general, export-import procedures are started from the step of receiving a shipment request from an exporter or an importer and terminated by transporting a corresponding object to an importer or an exporter, that is, a counterpart via procedures, such as a customs clearance, inland transport, warehousing confirmation, shipment, overseas transport, unloading, warehousing confirmation, a customs clearance and inland transport.

As described above, the export-import procedures must be based on the premise that information is organically exchanged and the present condition of a distribution is organically checked between principal agents because the export-import procedures have an urgent complicated business character that a plurality of distribution supervision companies must closely cooperate with each other.

Until today, a shipment request from the owner of cargo or the transfer of information between principal agents is chiefly performed through a facsimile, a telephone and/or e-mail. Accordingly, an error is generated in the transfer process because the transfer of information is one-time and atypical, thereby coming into a cause of a claim in the future.

Furthermore, when most of export and import agencies receive shipment requests in this way, they input such contents into the systems of their companies, and notify related companies, such as an airline, a ship company, an overseas agent, a console company, a packaging company, a safe-deposit company, an insurance company, a customs clearance company and an unloading company of the inputted contents through a facsimile, e-mail and/or a telephone.

However, when the shipment requests are terminated in this way, on-going situations or processing results need to be input to the systems in order to feed them back to the related companies after checking the on-going situations or processing results one by one through a facsimile, mail and/or a telephone. Accordingly, in order to terminate the international distribution of one case, such tasks, such as requests, middle checks and feedback, are repeated to add a load of business of export and import agencies and cause to increase a distribution cost for the owners of goods. Furthermore, a claim is generated due to an error generated in such a complicated business process.

Accordingly, there is a need for an environment which can solve such conventional inconvenience and which can more conveniently integrate and manage shipment upon export and import.

### SUMMARY OF THE INVENTION

Accordingly, the present invention has been made keeping in mind the above problems occurring in the prior art, and an embodiment of the present invention enables a user to manage export-import cargo shipment more conveniently and efficiently by providing an integration and management environment in which cargo shipment can be requested and managed upon export and import through an application which may be installed on a portable terminal.

An embodiment of the present invention enables a user to more conveniently receive information about a container truck and ship on which cargo has been loaded through an application.

According to an embodiment of the present invention, there is provided a method for integrating and managing a shipment request using a cargo tracking application, including a first step of accessing, by a portable terminal, a cargo shipment management server through the application by executing the application, receiving the shipment course items of cargo, and displaying the shipment course items; a second step of receiving, by the portable terminal, an input screen for shipment details information from the cargo shipment management server when any one of the shipment course items is selected, displaying the input screen, receiving the shipment details information, and transmitting the received shipment details information to the cargo shipment management server; a third step of completing, by the cargo shipment management server, the receipt of a shipment request by receiving the shipment details information and providing shipment request receipt information to the portable terminal; a fourth step of providing, by the cargo shipment management server, the portable terminal with information about the car dispatching of a container truck on which the cargo has been loaded; and a fifth step of providing, by a ship location providing server, the portable terminal with information about the location of a ship on which the cargo has been loaded.

In accordance with another embodiment of the present invention, the first step may include receiving, by the portable terminal, the shipment course items including the export port, arrival port, ship company, ship name, sailing date or arrival date of the cargo and displaying the received shipment course items.

In accordance with another embodiment of the present invention, the second step may include receiving, by the portable terminal, the shipment details information including the export port, arrival port, number of packages, weight or volume of the cargo and transmitting the received shipment details information to the cargo shipment management server.

In accordance with another embodiment of the present invention, the third step may include providing, by the cargo shipment management server, a ship company, ship name, sailing date or arrival date to the portable terminal.

In accordance with another embodiment of the present invention, the fourth step may include providing, by the cargo shipment management server, the portable terminal with information about the location of the container truck in a map form.

In accordance with another embodiment of the present invention, the fifth step may include providing, by the ship location providing server, the portable terminal with the information about the location of the ship on which the cargo has been loaded in a map form.

According to an embodiment of the present invention, there is provided a system for integrating and managing a shipment request using a cargo tracking application, including a cargo shipment management server configured to provide information about the shipment of cargo and a portable terminal configured to access the cargo shipment management server by executing the cargo tracking application. The portable terminal accesses a cargo shipment management server through the application by executing the application, receives the shipment course items of the cargo, displays the shipment course items, receiving an input screen for shipment details information from the cargo shipment management server when any one of the shipment course items is selected, displays the input screen, receives the shipment details information, and transmits the received shipment details information to the cargo shipment management server. The cargo shipment management server includes an application processing unit configured to provide the application to the portable terminal, a shipment receipt processing unit configured to complete the receipt of a shipment request by receiving the shipment details information and to provide shipment request receipt information to the portable terminal, and a car dispatching information providing unit configured to provide the portable terminal with information about the car dispatching of a container truck on which the cargo has been loaded. The system further includes a ship location providing server configured to provide the portable terminal with information about the location of a ship on which the cargo has been loaded.

In accordance with another embodiment of the present invention, the shipment course items may include the export port, arrival port, ship company, ship name, sailing date or arrival date of the cargo.

In accordance with another embodiment of the present invention, the shipment details information may include the export port, arrival port, number of packages, weight or volume of the cargo.

In accordance with another embodiment of the present invention, the shipment receipt processing unit may provide the portable terminal with a ship company, ship name, sailing date or arrival date when the receipt of the shipment request is completed by receiving the shipment details information.

In accordance with another embodiment of the present invention, the car dispatching information providing unit may provide the portable terminal with information about the location of the container truck in a map form.

In accordance with another embodiment of the present invention, the ship location providing server may provide the portable terminal with the information about the location of the ship on which the cargo has been loaded in a map form.

### BRIEF DESCRIPTION OF THE DRAWINGS

FIG. 1 is a conceptual diagram of a system for integrating and managing a shipment request using a cargo tracking application according to an embodiment of the present invention.

FIGS. 2 to 18 are diagrams for illustrating a method for integrating and managing a shipment request using a cargo tracking application according to an embodiment of the present invention.

### DETAILED DESCRIPTION

Hereinafter, embodiments of the present invention are described in detail with reference to the accompanying drawings. However, in describing the embodiments, a detailed description of the known function or element related to the present invention will be omitted if it is deemed to make the gist of the present invention unnecessarily vague. Furthermore, it is to be noted that in the drawings, the size of each element may have been exaggerated and does not correspond to an actual size.

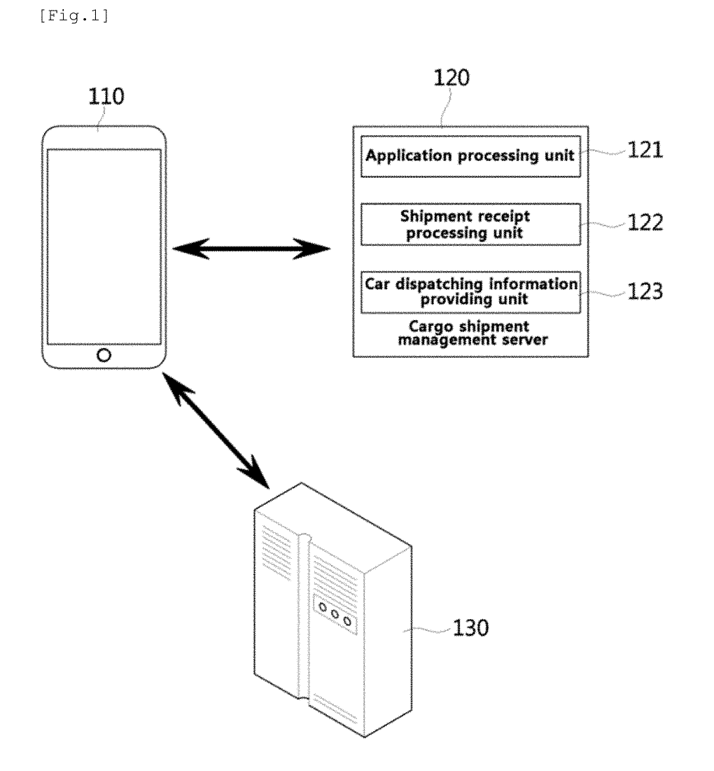

FIG. 1 is a conceptual diagram of a system for integrating and managing a shipment request using a cargo tracking application according to an embodiment of the present invention.

Hereinafter, the system for integrating and managing a shipment request using a cargo tracing application according to an embodiment of the present invention is described with reference to FIG. 1.

As shown in FIG. 1, the system for integrating and managing a shipment request using a cargo tracking application according to an embodiment of the present invention is configured to include a portable terminal 110, a cargo shipment management server 120 and a ship location providing server 130.

The portable terminal 110 according to an embodiment of the present invention may be configured as a smart terminal on which an application can be installed. When the application processing unit 121 of the cargo shipment management server 120 provides an application to the portable terminal 110, the portable terminal 110 may install the provided application thereon, may access the cargo shipment management server 120 through the application, and may receive cargo shipment-related information from the cargo shipment management server 120.

More specifically, the portable terminal 110 may access the cargo shipment management server 120 through the installed application, may receive the shipment course items of cargo from the shipment receipt processing unit 122 of the cargo shipment management server 120, and may display the received shipment course items.

In this case, the shipment course items of the cargo may include the export port, arrival port, ship company, ship name, sailing date or arrival date of the cargo. The portable terminal 110 may receive the shipment course items, including the export port, arrival port, ship company, ship name, sailing date or arrival date of the cargo, from the shipment receipt processing unit 122 of the cargo shipment management server 120, and may display the received shipment course items.

Furthermore, when any one of the shipment course items is selected, the portable terminal 110 receives an input screen for shipment details information from the shipment receipt processing unit 122 of the cargo shipment management server 120, displays the received input screen, receives the shipment details information from a user, and transmits the received shipment details information to the cargo shipment management server 120.

In this case, the portable terminal 110 may receive the shipment details information, including the export port, arrival port, number of packages, weight or volume of the cargo, from the user, and may transmit the received shipment details information to the cargo shipment management server 120.

The shipment receipt processing unit 122 of the cargo shipment management server 120 receives the shipment details information, completes the receipt of a shipment request, and provides information about the completed shipment request receipt to the portable terminal 110.

More specifically, when the receipt of the shipment request is completed, the shipment receipt processing unit 122 of the cargo shipment management server 120 may provide the ship company, ship name, sailing date or arrival date the receipt of which has been completed to the portable terminal 110 so that the ship company, ship name, sailing date or arrival date is displayed.

Furthermore, in accordance with an embodiment of the present invention, the car dispatching information providing unit 123 of the cargo shipment management server 120 provides the portable terminal 110 with information about the car dispatching of a container truck on which the cargo has been loaded. In this case, the car dispatching information providing unit 123 of the cargo shipment management server 120 may provide the portable terminal 110 with information about the location of the container truck in a map form.

More specifically, the portable terminal 110 may receive the information about the location of the container truck on a map that is directly provided by the car dispatching information providing unit 123 of the cargo shipment management server 120 on the application. In another embodiment, the portable terminal 110 may be configured to download a separate map application, install the downloaded map application, and receive the information about the location of the container truck from a map information providing server.

Furthermore, in accordance with an embodiment of the present invention, the ship location providing server 130 is configured to provide the portable terminal 110 with the information about the location of the ship on which the cargo has been loaded.

More specifically, the ship location providing server 130 may provide the portable terminal 110 with the information about the location of the ship on which the cargo has been loaded in a map form.

Accordingly, the system for integrating and managing a shipment request using a cargo tracking application according to an embodiment of the present invention provides an integration and management environment in which cargo shipment can be requested and managed upon export and import through an application which may be installed on a portable terminal. Accordingly, a user can manage export-import cargo shipment more conveniently and efficiently.

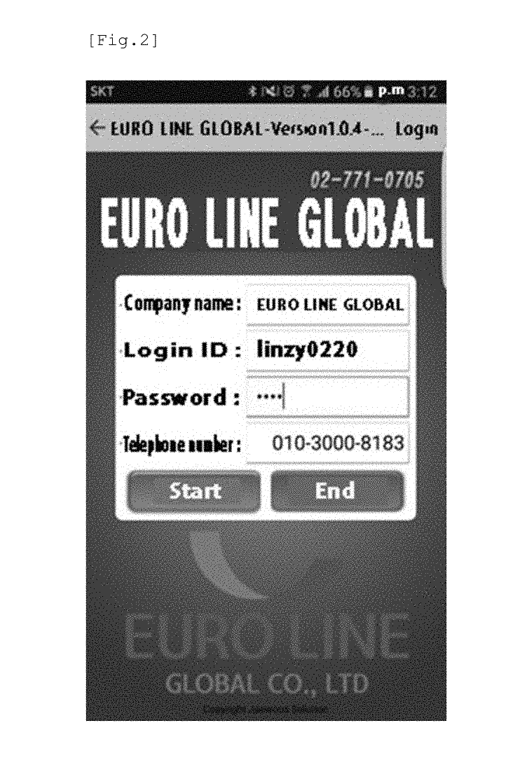

FIGS. 2 to 14 are diagrams for illustrating a method for integrating and managing a shipment request using a cargo tracking application according to an embodiment of the present invention.

The method for integrating and managing a shipment request using a cargo tracking application according to an embodiment of the present invention is described below with reference to FIGS. 2 to 14.

First, a user may download a cargo tracking application through the portable terminal, may execute the cargo tracking application, and may log in to the cargo tracking application by entering a company name, a login ID, a password and a telephone number as shown in FIG. 2. In this case, for such login, a separate member registration process may be further included.

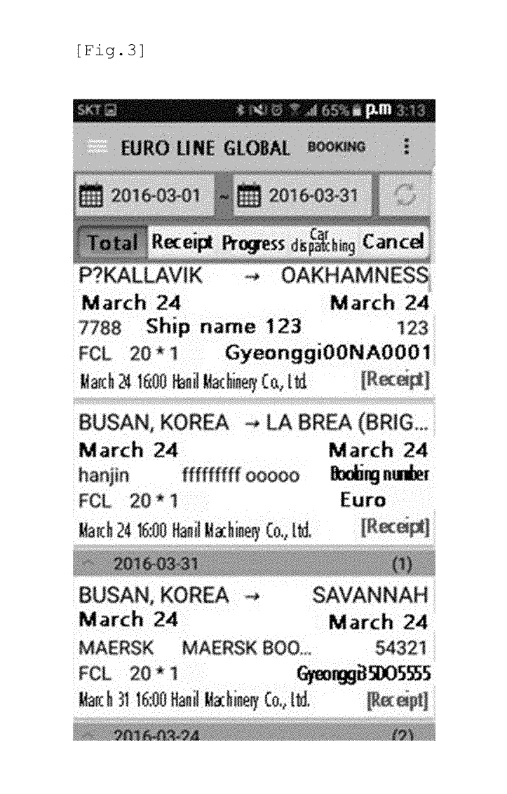

When the login is performed, the portable terminal may access the cargo shipment management server through the cargo tracking application, may receive the shipment course items of cargo, and may display the received shipment course items as shown in FIG. 3.

In this case, as shown in FIG. 3, each of the shipment course items displayed by the portable terminal may include and display the export port, arrival port, ship company, ship name, sailing date or arrival date of the cargo.

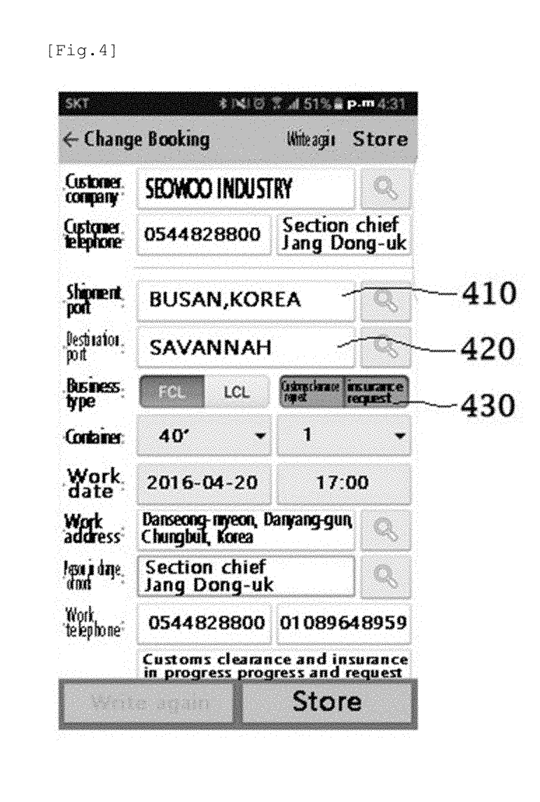

Accordingly, the user selects any one of the shipment course items displayed on the portable terminal for a shipment request. As shown in FIG. 4, the portable terminal may receive an input screen for shipment details information from the cargo shipment management server and display the received input screen.

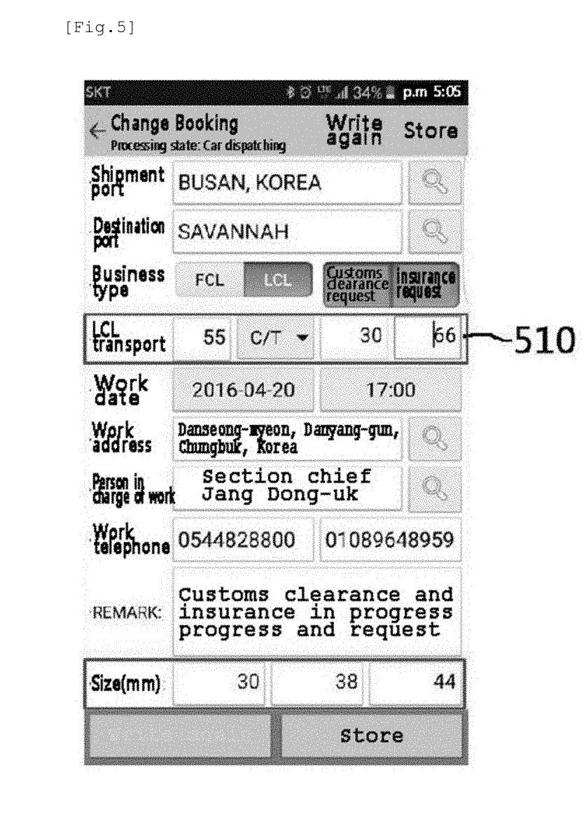

Accordingly, as shown in FIGS. 4 and 5, the user may enter the shipment details information on a screen of the application installed on the portable terminal.

More specifically, as shown in FIG. 4, the user may select boxes for the export port 410 and arrival port 420 of the cargo on the screen of the cargo tracking application of the portable terminal, may enter the export port 410 and arrival port 420 of the cargo, and may additionally select a box for a customs clearance request and insurance request 430.

Furthermore, as shown in FIG. 5, the user may select a box for shipment details information 510, including the number of packages, weight or volume, on a screen of the cargo tracking application of the portable terminal, may enter the shipment details information 510, and may transmit it to the cargo shipment management server.

Accordingly, the cargo shipment management server may complete the receipt of the shipment request by receiving the shipment details information, and may provide information about the completed shipment request receipt to the portable terminal.

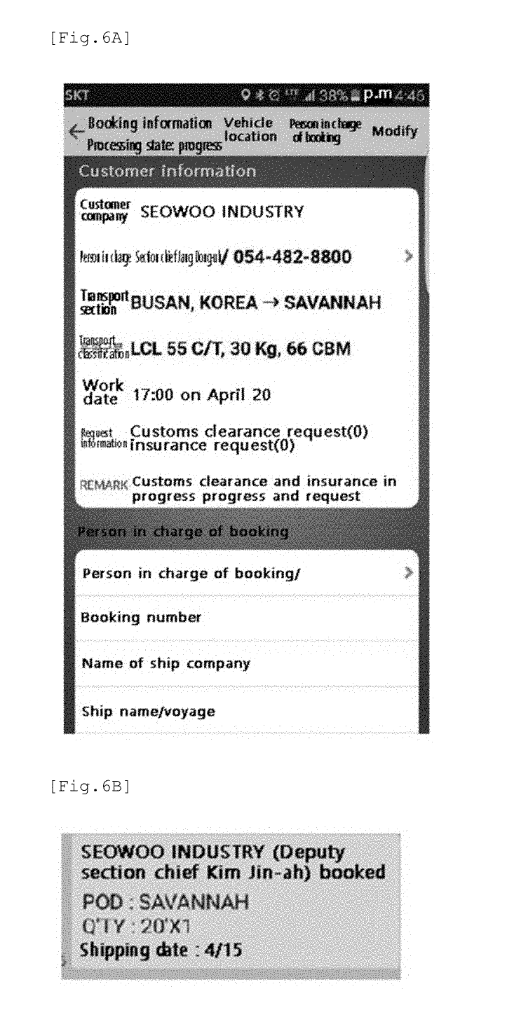

Accordingly, as shown in FIG. 6A, the user may check the receipt information, including the detailed contents of the shipment request of an exporter including customer company information, the name of the person in charge, a transportation period, a task date and requirements, on a screen of the allocation of the portable terminal.

In accordance with an embodiment of the present invention, if booking receipt from the owner of cargo is performed as shown in FIG. 6B, the present invention may be implemented in such a manner that the contents of a shipment request from an exporter or an importer are transmitted to the PC or smart phone of the person in charge who performs export or import management in a notification or notice form, such as a text message, in real time through the cargo shipment management server.

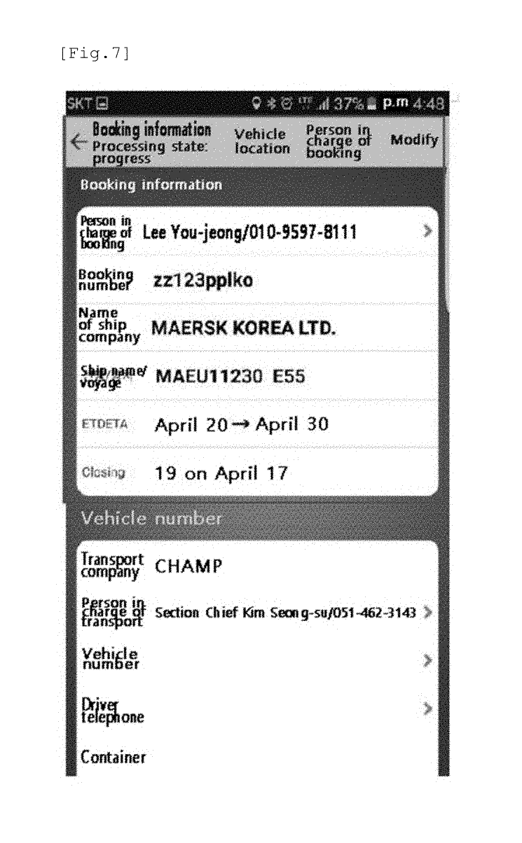

Furthermore, as shown in FIG. 7, the user may receive the ship company, ship name, sailing date or arrival date from the cargo shipment management server through a screen of the cargo tracking application of the portable terminal. For example, when a shipment request is received, the cargo shipment management server notifies an exporter that the shipment request has been received.

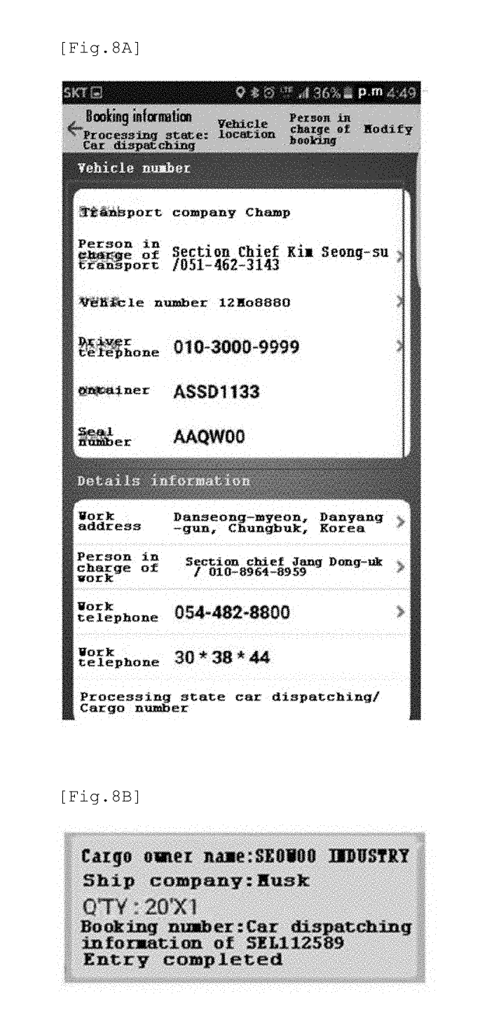

Furthermore, as shown in FIG. 8A, the cargo shipment management server may provide the portable terminal with information about the car dispatching of a container truck on which the cargo has been loaded, so the user may check the information about the car dispatching of the container truck on which the cargo has been loaded on a screen of the cargo tracking application of the portable terminal.

Moreover, in an embodiment of the present invention, when the contents of car dispatching receipt, such as that of FIG. 8A, are received, the present invention may be implemented in such a manner that the car dispatching receipt is transmitted to the PC or smart phone of the person in charge who performs export or import management in a notification or notice form, such as a text message, in real time through the cargo shipment management server.

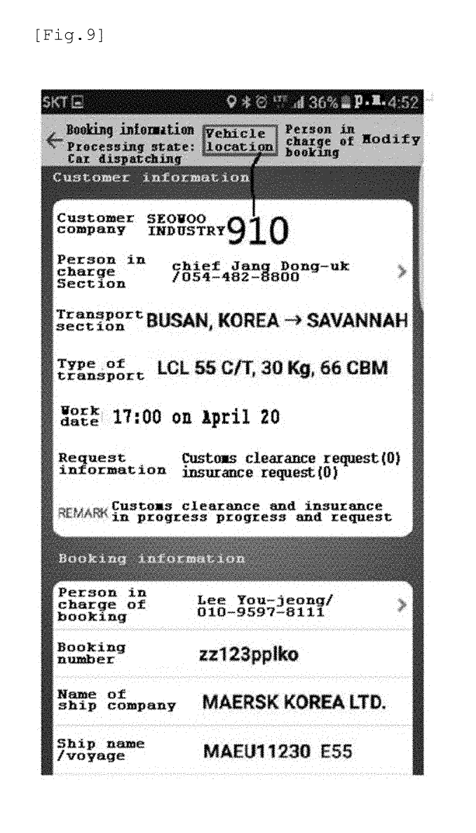

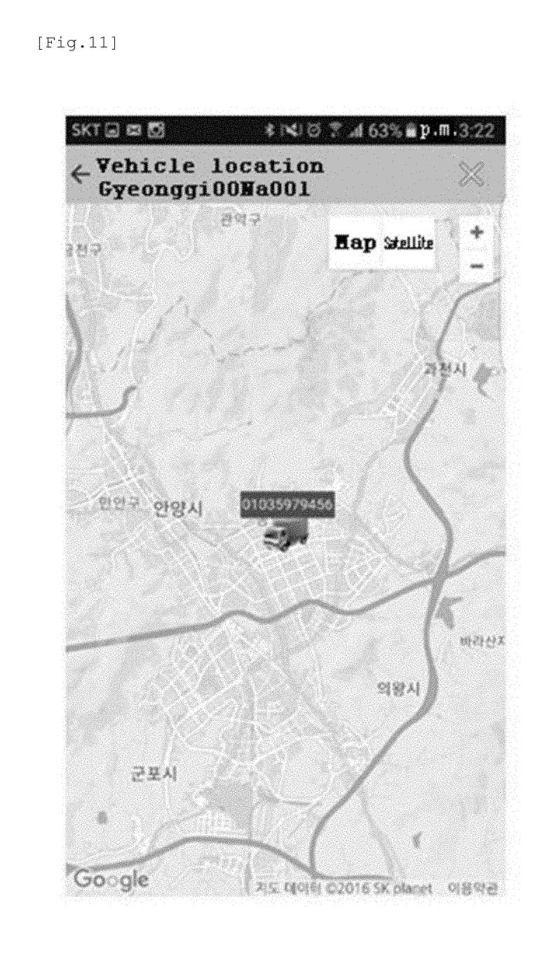

As shown in FIG. 9, the location button 910 of the container truck on which the cargo has been loaded is displayed on a screen of the cargo tracking application of the portable terminal. When the user selects the location button 910 of the container truck, information about the location of the container truck may be displayed on a screen of the cargo tracking application of the portable terminal in a map form as shown in FIG. 11.

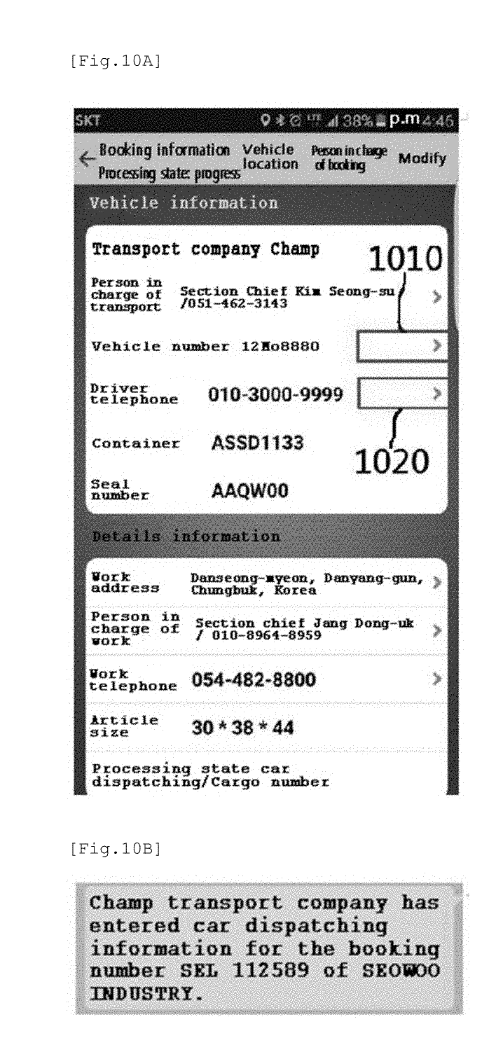

Furthermore, as shown in FIG. 10A, when the user presses a vehicle number 1010 for container truck information, the information about the location of the container truck shown in FIG. 11 may be displayed on a screen of the cargo tracking application of the portable terminal in a map form. The user may have a phone call immediately connected to a transport driver by selecting a driver telephone number 1020.

In accordance with an embodiment of the present invention, as shown in FIG. 10B, when car dispatching information is entered by a transport company which performs car dispatching through the cargo shipment management server, the present invention may be implemented in such a manner that a notification message for the car dispatching information is transmitted to the terminal of the owner of cargo or the PC or smart phone of the person in charge who performs export or import management in a notification or notice form, such as a text message, in real time through the cargo shipment management server.

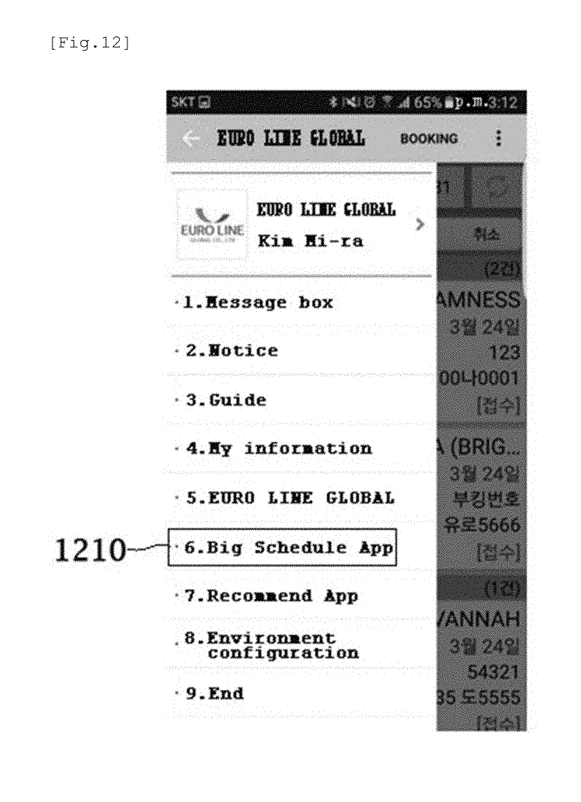

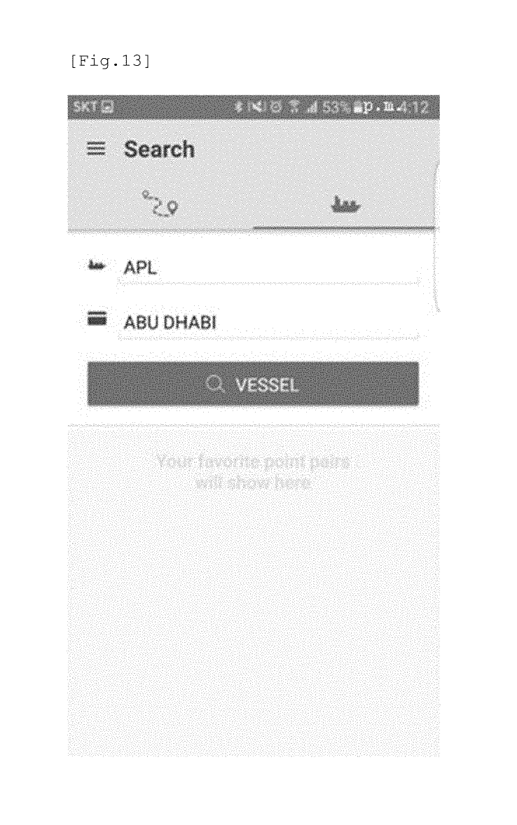

Thereafter, as shown in FIG. 12, when the user selects a cooperation shipment company site execution button 1210 in order to check the information about the location of the ship on which the cargo has been loaded on a screen of the cargo tracking application of the portable terminal, a cooperation shipment company site may be displayed through the portable terminal as shown in FIG. 13.

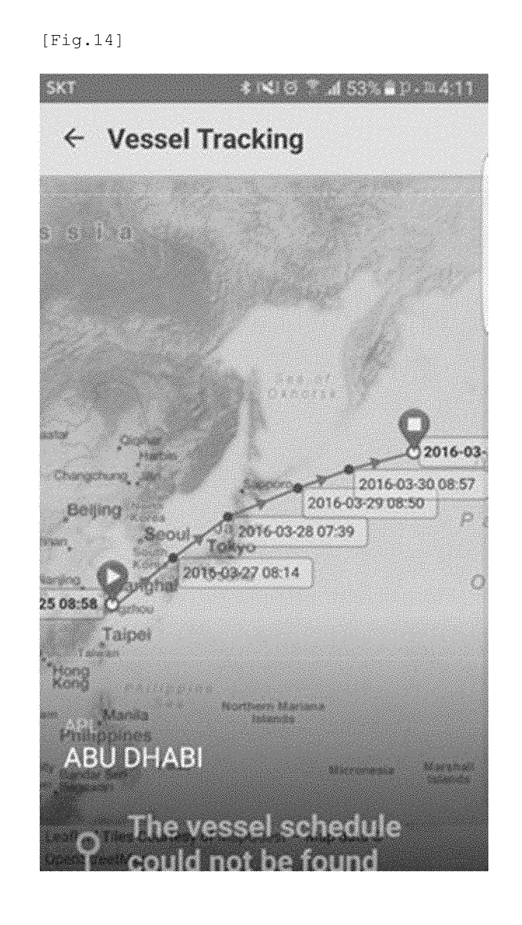

Accordingly, when the user enters a ship name on a screen of the cargo tracking application of the portable terminal as shown in FIG. 13, the information about the location of the ship on which the cargo has been loaded may be provided from the ship location providing server to the portable terminal as shown in FIG. 14.

That is, in accordance with an embodiment of the present invention, the user may be provided with the information about the location of the ship on which the cargo has been loaded in a map form through the portable terminal.

In accordance with another embodiment of the present invention, when a ship name is directly entered on a screen of the cargo tracking application of the portable terminal, the cargo shipment management server may provide information about the location of the ship on which cargo has been loaded in a map form. Alternatively, a separate map application may be downloaded and installed on the portable terminal, and the map information providing server may display information about the location of a ship on which cargo has been loaded on a screen of the map application a map form.

Accordingly, in accordance with an embodiment of the present invention, an integration and management environment in which cargo shipment can be requested and managed upon export and import is provided through the cargo tracking application which may be installed on the portable terminal. Accordingly, a user can mange export-import cargo shipment more conveniently and efficiently and can be provided with information about a container truck and ship on which cargo has been loaded more conveniently through the cargo tracking application.

Furthermore, the cargo tracking application of the portable terminal may be driven like the following implementation example even in the terminal of the driver of a truck.

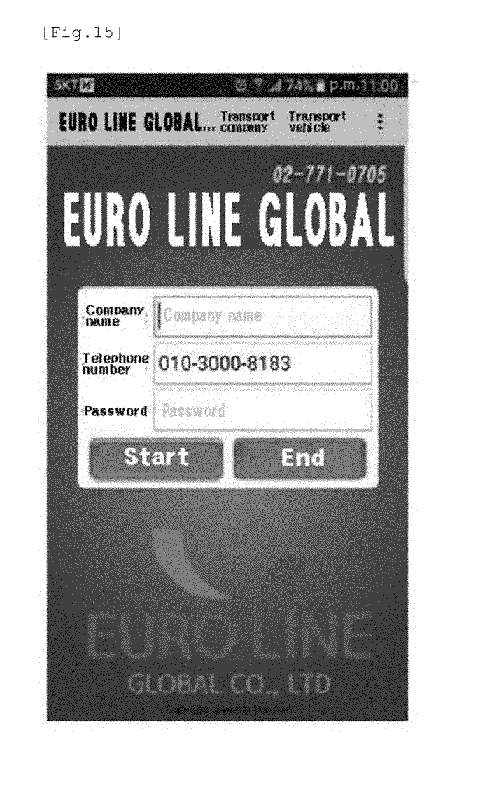

Referring to FIGS. 15 to 17, FIG. 15 shows an image of the operating state when the cargo tracking application according to an embodiment of the present invention is driven in the portable terminal of a truck driver.

As shown in FIG. 15, when the cargo tracking application according to an embodiment of the present invention is driven in the terminal of a truck driver, the location of cargo may be checked based on the location of the mobile phone of a user even through login to the cargo tracking application or even without login.

A truck driver executes the cargo tracking application in his or her terminal and immediately accesses the cargo tracking application by touching a transport vehicle button (in the case of a smart phone). At the same time, a cargo location tracking system is driven.

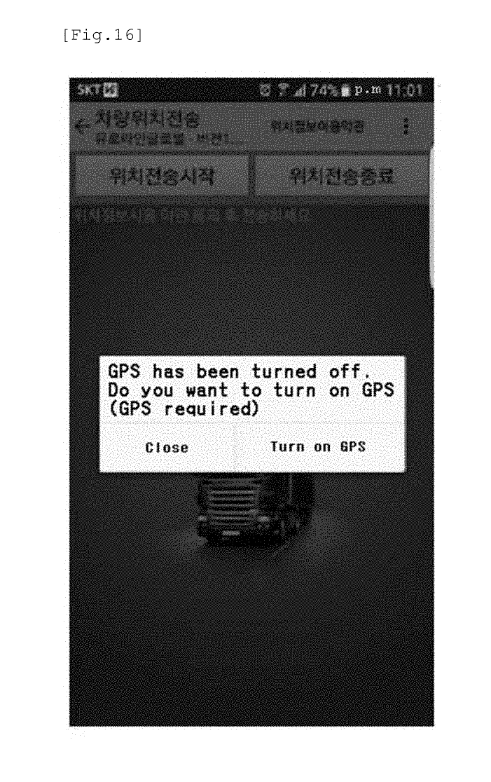

In this case, the cargo tracking application of the portable terminal of the truck driver checks whether GPSs are received as shown in FIG. 16, and the truck driver drives a GPS activation function in the cargo tracking application.

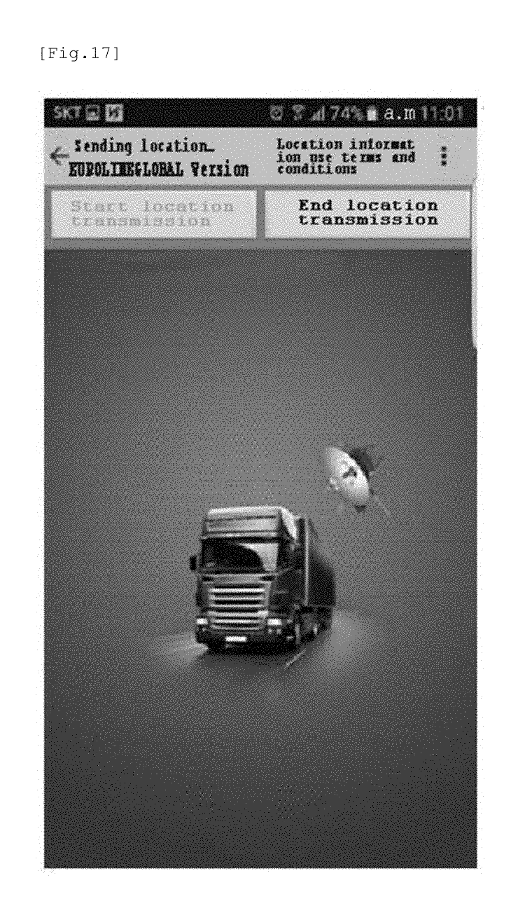

Thereafter, as shown in FIG. 17, when the truck driver presses a function button, such as a “location transmission start” proposed by the cargo tracking application according to an embodiment of the present invention, when cargo (or a container) starts to be transported, the location of the cargo may be tracked through the location of a portable terminal, such as the smart phone of a cargo owner.

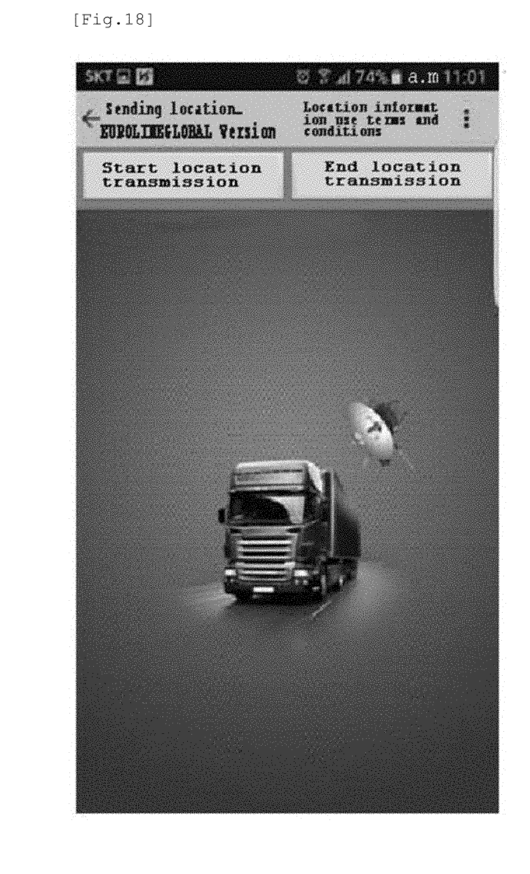

Thereafter, when the transport of the cargo is terminated, the truck driver may press a location transmission end button as shown in FIG. 18, thereby terminating the tracking of the location. This is for enabling the location of the cargo to be tracked while the cargo is moved.

In accordance with an embodiment of the present invention, an integration and management environment in which cargo shipment can be requested and managed upon export and import is provided through the cargo tracking application which may be installed on the portable terminal. Accordingly, a user can mange export-import cargo shipment more conveniently and efficiently.

Furthermore, in accordance with an embodiment of the present invention, a user can be provided with information about a container truck and ship on which cargo has been loaded more conveniently through the cargo tracking application.

As described above, the detailed embodiments of the present invention have been described in the detailed description. However, the present invention may be modified in various ways without departing from the category of the invention. Accordingly, the technological spirit of the present invention should not be limited to the aforementioned embodiments, but should be defined by not only the appended claims, but equivalents thereof.

What is claimed is:

1. A method for integrating and managing a shipment request using a cargo tracking application, the method comprising:
a first step of accessing, by a portable terminal, a cargo shipment management server through the application by executing the application, receiving shipment course items of cargo, and displaying the shipment course items;
a second step of receiving, by the portable terminal, an input screen for shipment details information from the cargo shipment management server when any one of the shipment course items is selected, displaying the input screen, receiving the shipment details information, and transmitting the received shipment details information to the cargo shipment management server;
a third step of completing, by the cargo shipment management server, a receipt of a shipment request by receiving the shipment details information and providing shipment request receipt information to the portable terminal;
a fourth step of providing, by the cargo shipment management server, the portable terminal with information about a car dispatching of a container truck on which the cargo has been loaded; and
a fifth step of providing, by a ship location providing server, the portable terminal with information about a location of a ship on which the cargo has been loaded.

2. The method of claim 1, wherein the first step comprises:
receiving, by the portable terminal, the shipment course items comprising an export port, arrival port, ship company, ship name, sailing date or arrival date of the cargo, and
displaying the received shipment course items.

3. The method of claim 1, wherein the second step comprises:
receiving, by the portable terminal, the shipment details information comprising an export port, arrival port, number of packages, weight or volume of the cargo, and
transmitting the received shipment details information to the cargo shipment management server.

4. The method of claim 1, wherein the third step comprises providing, by the cargo shipment management server, a ship company, ship name, sailing date or arrival date to the portable terminal.

5. The method of claim 1, wherein the fourth step comprises providing, by the cargo shipment management server, the portable terminal with information about a location of the container truck in a map form.

6. The method of claim 1, wherein the fifth step comprises providing, by the ship location providing server, the portable terminal with the information about the location of the ship on which the cargo has been loaded in a map form.

7. A system for integrating and managing a shipment request using a cargo tracking application, the system comprising a cargo shipment management server configured to provide information about a shipment of cargo and a portable terminal configured to access the cargo shipment management server by executing the cargo tracking application, wherein:
the portable terminal accesses a cargo shipment management server through the application by executing the application, receives shipment course items of the cargo, displays the shipment course items, receiving an input screen for shipment details information from the cargo shipment management server when any one of the shipment course items is selected, displays the input screen, receives the shipment details information, and transmits the received shipment details information to the cargo shipment management server,
the cargo shipment management server comprises an application processing unit configured to provide the application to the portable terminal, a shipment receipt processing unit configured to complete a receipt of a shipment request by receiving the shipment details information and to provide shipment request receipt information to the portable terminal, and a car dispatching information providing unit configured to provide the portable terminal with information about a car dispatching of a container truck on which the cargo has been loaded, and
the system further comprises a ship location providing server configured to provide the portable terminal with information about a location of a ship on which the cargo has been loaded.

8. The system of claim 7, wherein the shipment course items comprise an export port, arrival port, ship company, ship name, sailing date or arrival date of the cargo.

9. The system of claim 7, wherein the shipment details information comprises an export port, arrival port, number of packages, weight or volume of the cargo.

10. The system of claim 7, wherein the shipment receipt processing unit provides the portable terminal with a ship company, ship name, sailing date or arrival date when the receipt of the shipment request is completed by receiving the shipment details information.

11. The system of claim 7, wherein the car dispatching information providing unit provides the portable terminal with information about a location of the container truck in a map form.

12. The system of claim 7, wherein the ship location providing server provides the portable terminal with the information about the location of the ship on which the cargo has been loaded in a map form.
